(19) United States
(12) Patent Application Publication
(10) Pub. No.: US 2007/0189685 A1
(43) Pub. Date: Aug. 16, 2007

(54) OPTICAL FIBER AND METHOD OF FORMING ELECTRODES OF PLASMA DISPLAY PANEL

(75) Inventors: Jung-Hyuck Choi, Suwon-si (KR); Cheol-Lae Roh, Suwon-si (KR); Gyoo-Wan Han, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/674,369

(22) Filed: Feb. 13, 2007

(30) Foreign Application Priority Data
Feb. 15, 2006 (KR) 2006-14710

(51) Int. Cl. G02B 6/02; G02B 6/10

(52) U.S. Cl. 385/123; 385/146

(57) ABSTRACT

An optical fiber can increase efficiency of a laser source and can uniformly distribute the intensity of laser beam when patterning electrodes using a laser. A plasma display panel uses the optical fiber. The shape of a cross-sectional shape of an inner side of the optical fiber is formed to correspond to an outer rim of a pattern mask. The optical fiber transmits light and is connected to the laser source.

### CROSS-REFERENCE TO RELATED APPLICATION

This application claims the benefit of Korean Application No. 2006-14710, filed Feb. 15, 2006 in the Korean Intellectual Property Office, the disclosure of which is incorporated herein by reference.

### BACKGROUND OF THE INVENTION

1. Field of the invention

Aspects of the present invention relate to an optical fiber and a method of forming electrodes of plasma display panels, and more particularly, to an optical fiber in which a cross-section of a core in an inner side of the optical fiber has a rectangular shape and/or profile to increase the efficiency of a laser beam emitted from a laser source when a laser patterning to form electrodes is performed on a substrate, and a method of forming electrodes of the plasma display panels.

2. Description of the Related Art

A plasma display panel includes a front panel and a rear panel, and a plurality of sustain electrode pairs and a plurality of address electrodes, which are respectively formed on front and rear substrates that form the respective panels. The respective electrodes are formed using a printing method, a photolithography method, a lift-off method, or an etching method. As an example, in the case of the photolithography method, the electrodes are formed by coating and drying a photosensitive paste having functional components on a substrate, then exposing and developing the photosensitive paste through a photomask.

Also, in a laser patterning method, a particular pattern of the respective electrodes is formed by passing a laser beam emitted from a laser source through an optical system using a pattern mask. However, when the laser beam passes through a related art optical system, the intensity of the laser beam is not uniform. Therefore, a homogenizer lens must be additionally used to form a uniform laser beam.

### SUMMARY OF THE INVENTION

Aspects of the present invention includes an optical fiber that transmits light by being connected to a laser source, in which a cross-sectional shape of an inner side of the optical fiber is shaped to correspond to an outer rim of a pattern mask and a method of forming one or more electrodes of a plasma display panel.

The cross-sectional shape of the inner side of the optical fiber may be rectangular, and apex portions of the rectangular shape may be rounded.

According to an aspect of the present invention, a method of forming an optical fiber includes: coating an electrode paste on a surface of a substrate; moving the substrate on which the electrode paste is coated; aligning a spot to irradiate a laser beam on a location of the substrate where an electrode pattern will be formed by operating one or more optical elements located on a laser discharge end of an optical fiber that is connected to a laser source; and radiating the laser beam onto the electrode paste coated on the substrate through the optical fiber, wherein the cross-sectional shape of an inner side of the optical fiber corresponds to an outer rim of a pattern mask.

The cross-sectional shape of the inner side of the optical fiber may be rectangular, and apex portions of the rectangular shape may be rounded.

The cross-sectional shape of the inner side of the optical fiber may correspond to an outer rim of a pattern mask to be used in patterning a substrate of a plasma display panel using a laser.

The method of forming an optical fiber according to aspects of the present invention can increase the efficiency of a laser beam source by minimizing or removing extraneous spaces to which irradiation of the laser beam is unnecessarily. Also, the intensity distribution of laser beam can be made even since the laser beam is transmitted through an optical fiber. Therefore, an additional homogenizer lens is unnecessary.

According to an aspect of the present invention, a method of patterning electrodes on a substrate of a plasma display panel without using a homogenizing lens includes: moving the substrate coated with an electrode paste under at least one optical element; aligning the at least one optical element at a predetermined position of the substrate; and irradiating a beam of light onto the predetermined position of the substrate through an optical fiber that evens the beam of light through a cross-sectional shape of a core of the optical fiber that corresponds to a profile of a pattern mask used to pattern the electrodes on the substrate.

According to an aspect of the present invention, an optical fiber includes: a core; and a clad, wherein a cross-sectional shape of the core corresponds to a profile of a pattern mask used to pattern electrodes on a plasma display panel.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a cross-sectional view illustrating an inner side of an optical fiber according to an aspect of the present invention;

FIG. 2 is a cross-sectional view illustrating an inner side of an optical fiber according to another aspect of the present invention;

FIG. 3 is a flow chart of a method of forming electrodes of a plasma display panel according to an aspect of the present invention;

FIGS. 4A through 4C are schematic drawings illustrating a method of forming an electrode according to an aspect of the present invention; and

FIG. 5 is an enlarged view of a region indicated by “a” in FIG. 4C.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

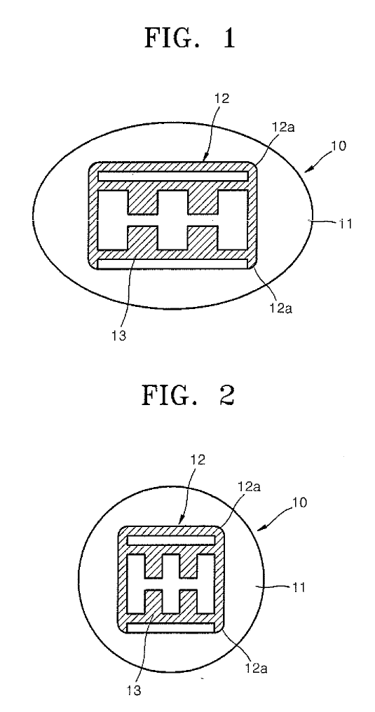

FIG. 1 is a cross-sectional view illustrating an inner side of an optical fiber according to an aspect of the present invention. In FIGS. 1 and 2, a pattern mask 13 is not actually present inside an optical fiber 10. Rather, the pattern mask 13 is depicted for convenience of explanation, and is shown superimposed over the cross-sectional view of the inner side of the optical fiber 10 to show the corresponding shapes of the pattern mask 13 and the inner side of the optical fiber 10.

The optical fiber 10 is an optical signal transmitting path to transmit one or more optical signals. The optical fiber 10 includes a core 12 through which the optical signals are transmitted, and a clad (or cladding) 11 that surrounds the core 12. The clad 11 is further surrounded by a covering material (not shown). As the core 12 is formed of a material having a larger reflective index than the clad 11, a laser beam incident through an end of the optical fiber 10 is transmitted through the optical fiber 10 by total reflection within the core 12 and is emitted through the other end of the optical fiber 10.

In a non-limiting aspect of FIG. 1, an outer rim (profile or outline) of the core 12 in the cross-section of the optical fiber 10 has a rectangular shape (or is rectangular), and apex portions (or corners) 12a of the rectangular outer rim are rounded. Accordingly, a laser beam that is incident through an end of the optical fiber 10 is transmitted therethrough by being totally reflected in the core 12 having a rectangular shape with rounded apexes portions 12a. In other aspects, the shape of the outer rim of the core 12 is a non-rectangular shape.

Once the laser beam passes through and is emitted through the optical fiber 10, the laser beam is radiated through the pattern mask 13 onto an electrode paste coated on a substrate in a desired patterned shape. At this point, the shape and/or the profile of the cross-section of an inner side of the optical fiber 10 (that is, the cross-sectional shape and/or the profile of the core 12) should be formed to correspond to the outer rim of the pattern mask 13, though not required.

If the cross-sectional shape of the core 12 does not correspond to the outer rim of the pattern mask 13, such as when the shape of the cross-section (that is, a boundary surface between the core 12 and the clad 11 of the optical fiber 10) is circular or oval, then the cross-sectional shape of the core 12 would not match the profile of the pattern mask 13, the profile thereof which is rectangular. If so, portions of the laser beam will be radiated to empty spaces (non-overlapping areas) defined by the shape difference between the outer rim (profile or outline) of the pattern mask 13 and the outer rim (profile or outline) of the core 12. A portion of a laser beam that is radiated to the empty spaces (non-overlapping area) is wasted and reduces the efficiency of the laser beam source.

In a non-limiting aspect, the shape of the outer rim (profile or outline) of the core 12 according to an aspect of the present invention has a rectangular shape corresponding to the shape of the outer rim (profile or outline) of the pattern mask 13. Therefore, the laser beam is not radiated to an unnecessary space (or non-overlapping areas), to thereby increase the efficiency of the laser beam source.

In a non-limiting aspect, the rectangular shape of the cross-section of an inner side of the optical fiber 10, as depicted in FIG. 2, can have different (or varying) aspect ratios. That is, the ratio of width to length of the electrode pattern to be formed on the substrate can be varied. This is because optical elements, such as a series of lenses (not shown), are connected to one end and an opposite end of the optical fiber 10 that is connected to a laser source. The aspect ratio of the laser beam that is emitted through the lenses can be controlled using the lenses. In other aspects, the aspect ratio of the core 12 may be different from that of horizontal/vertical lengths ratio (aspect ratio) of the electrode pattern to be formed on the substrate.

In a non-limiting aspect shown in FIG. 1, the shape of the cross-section of an inner side of the optical fiber 10 according to an aspect of the present invention is rectangular. However, aspects of the present invention are not limited thereto. That is, various shapes (of the cross-section of an inner side of the optical fiber 10 (or the core 12)) that correspond to the outer rim shape of the pattern mask 13 are within the scope of the present invention.

The rounded apex portions 12a of the rectangular shape can prevent the concentration of the laser beam on the apex portions 12a because the corners are eliminated. Accordingly, damage of the optical fiber 10 by concentration of the laser beam can be reduced or prevented.

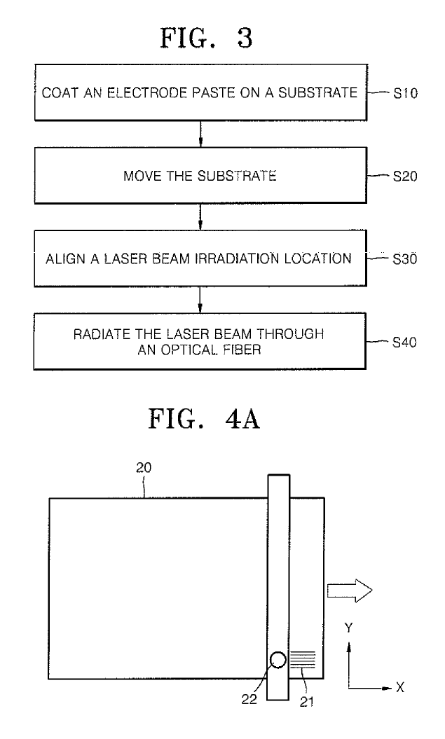

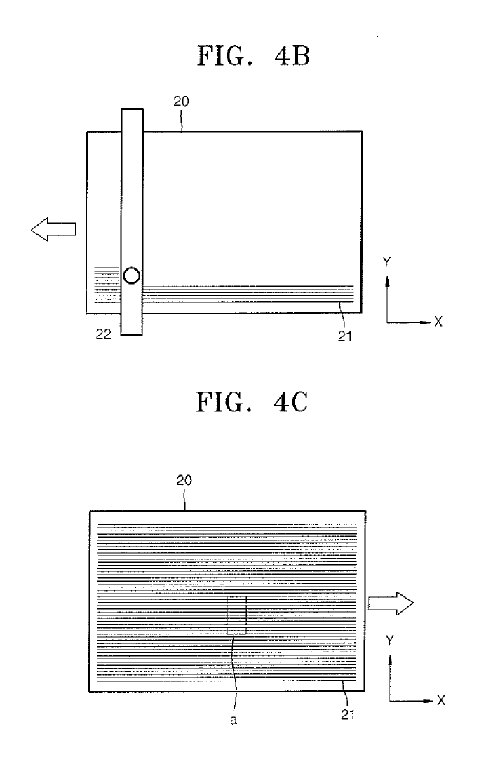

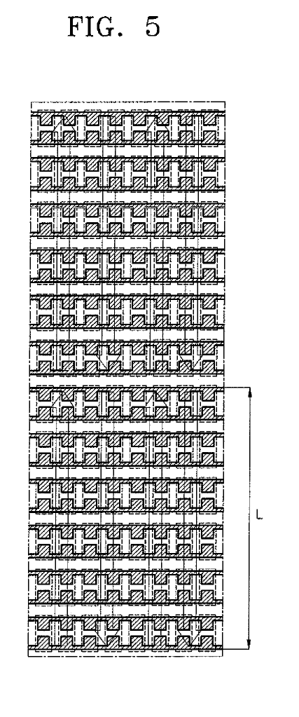

Hereinafter, a method of forming electrodes (particularly, transparent electrode pairs) of a plasma display panel using an optical fiber according to an aspect of the present invention will be described. FIG. 3 is a flow chart of a method of forming electrodes of a plasma display panel according to an aspect of the present invention. FIGS. 4A through 4C are schematic drawings illustrating a method of forming an electrode according to an aspect of the present invention. FIG. 5 is an enlarged view of a region indicated by “a” in FIG. 4C. In various aspects, the electrode may be transparent.

As shown in FIG. 3, a substrate 20 is first prepared. The substrate 20 can be usually formed of transparent glass, but aspects of the present invention are not limited thereto. Once the substrate 20 is prepared, an electrode paste containing a functional component (or a desired component) is uniformly coated to a predetermined thickness on a surface of the substrate 20 (operation S10).

Once coated, the substrate 20 is fixed onto a work table (not shown). The work table is movable in positive and negative directions (or first and second directions) of an X axis (or a first axis). Initially, the work table is positioned (or moved) so that a laser head 22 can be positioned at a right corner of the substrate 20 (operation S20). An end of the optical fiber 10 is connected to a laser source, and the other end of the optical fiber 10 is connected to series of lenses such as a collimator and/or a scanner mirror or mirrors. The scanner mirror allows a laser beam to be radiated to a predetermined range by controlling an angle of the mirror. That is, the scanner mirror allows a spot of the laser beam to be moved along a predetermined line and/or within a predetermined area. Also, the distribution of beam intensity of the laser beam can be made uniform or even by transmitting the laser beam through the optical fiber 10. Accordingly, unlike in the related art, an additional homogenizer lens is unnecessary.

Referring back to FIG. 3, once the substrate 20 is positioned or moved, the laser head 22 and the scanner mirror (not shown) are aligned such that the laser beam is radiated to an initial location of the substrate 20 where an electrode pattern 21 is to be formed. The laser beam is radiated through the optical fiber 10 for a predetermined timeframe (operation S40). When the electrode pattern 21 is formed on the substrate 20 by the above, the scanner mirror is aligned to a next location of the substrate 20 where the electrode pattern 21 is to be formed (operation S30). Then, the laser beam is again radiated (operation S40).

Once the scanner mirror has performed radiating of the laser beam along a predetermined length L, as shown in FIG. 5, the substrate 20 is moved by a predetermined distance in the X axis direction (operation S20. Thereafter, the scanner mirror is operated along a direction opposite to that of the previous movement or alignment, which is alignment toward an upper direction in the view of FIG. 4A (the Y axis direction, or a second direction) (operation S30). Thereafter, the laser beam is radiated (which may or may not be at the same time) (operation S40).

The process is repeated so that each time after the substrate 20 is moved by a predetermined distance in the X axis direction (operation S20), the electrode pattern 21 is formed by radiating the laser beam alternately up and down over the scan length L (or predetermined length L) as described above (operations S30, S40). In various aspects, as the laser beam has a very high energy density, portions of the electrode paste onto which the laser beam is radiated are cut out. In this manner, a series of an X electrode and a Y electrode pair extending in the X axis direction are formed. In various aspects, the series may extend in the Y axis direction or any other desired direction.

Once forming a row of the series of the X electrode and the Y electrode pair extending in the X axis is complete, the laser head 22 is moved by a predetermined distance upward (or perpendicularly to the extending direction of the X electrode and Y electrode pairing) and is fixed, and the substrate 20 is moved in the negative direction of the X axis (operation S20). After the scanner mirror is aligned to a location where the electrode pattern 21 is to be formed (operation S30) by operation of the scanner mirror, the laser beam is radiated (operation S40). By repeating the above process, another series of the X electrode and the Y electrode pair are formed on the upper side of the previously formed series of X electrodes and Y electrode pairs. Also, by repeating the above processes, a plurality of X electrodes and Y electrode pairs extending in the X axis direction are formed on the entire surface of the substrate 20. In various aspects, the movement thereof in forming the X electrode and the Y electrode pairs may outline a square wave pattern, or something similar. In various aspects, the movement thereof enables irradiating of substantially the entire surface of the substrate.

Up to this point, a method of forming a transparent electrode has been described as an example to explain the method of forming electrodes of a plasma display panel according to an aspect of the present invention. Nevertheless, the scope of the present invention is not limited thereto but includes a method of forming a pattern of bus electrodes on the transparent electrodes.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. An optical fiber that transmits light by being connected to a laser source, wherein a cross-sectional shape of an inner side of the optical fiber corresponds to an outer rim of a pattern mask.

2. The optical fiber of claim 1, wherein the cross-sectional shape of the inner side of the optical fiber is rectangular.

3. The optical fiber of claim 2, wherein rectangular cross-sectional shape of the inner side has apex portions that are rounded.

4. A method of forming plasma display panel comprising:
coating an electrode paste on a surface of a substrate;
moving the substrate on which the electrode paste is coated;
aligning a spot to irradiate a laser beam on a location of the substrate where an electrode pattern will be formed by operating one or more optical elements located on a laser discharge end of an optical fiber that is connected to a laser source; and
radiating the laser beam onto the electrode paste coated on the substrate through the optical fiber,
wherein a cross-sectional shape of an inner side of the optical fiber corresponds to an outer rim of a pattern mask.

5. The method of claim 4, wherein the cross-sectional shape of the inner side of the optical fiber is rectangular.

6. The method of claim 5, wherein rectangular cross-sectional shape of the inner side has apex portions that are rounded.

7. The optical fiber of claim 1, wherein the cross-sectional shape of the inner side of the optical fiber is of a core of the optical fiber.

8. The method of claim 4, wherein the cross-sectional shape of the inner side of the optical fiber is of a core of the optical fiber.

9. The method of claim 4, wherein the one or more optical elements are one or more lenses, a collimator, and/or one or more mirrors.

10. An optical fiber, comprising:
a core; and
a clad, wherein a cross-sectional shape of the core corresponds to a profile of a pattern mask used to pattern electrodes on a plasma display panel.

11. The optical fiber of claim 10, wherein the cross-sectional shape of the core is different from the cross-sectional shape of the clad.

12. The optical fiber of claim 10, wherein the cross-sectional shape of the core is rectangular and contains rounded apexes.

13. The optical fiber of claim 12, wherein the rectangular cross-sectional core evens transmission of a laser beam through the optical fiber.

14. The optical fiber of claim 10, wherein the core and the pattern mask each has an aspect ratio, and the aspect ratio of the core is one of same or different from the aspect ratio of the pattern mask.

15. A method of patterning electrodes on a substrate of a plasma display panel without using a homogenizing lens, comprising:
moving the substrate coated with an electrode paste under at least one optical element;
aligning the at least one optical element at a predetermined position of the substrate; and irradiating a beam of light onto the predetermined position of the substrate through an optical fiber that evens the beam of light through a cross-sectional shape of a core of the optical fiber that corresponds to a profile of a pattern mask used to pattern the electrodes on the substrate.

16. The method of claim 15, wherein the moving of the substrate occurs in a first direction and the aligning of the optical element occurs in a second direction that is substantially perpendicular to the first direction.

17. The method of claim 15, wherein the moving of the substrate and the aligning of the optical element together outlines a square wave pattern.

18. The method of claim 15, wherein the moving of the substrate and the aligning of the at least one optical element together enables irradiating of the beam of light onto substantially the entire surface of the substrate.

19. The method of claim 15, wherein the at least one optical element includes a collimator and/or a scanner mirror.

20. The method of claim 15, wherein the cross-sectional shape of the core of the optical fiber is rectangular.
